(19) United States
(12) Patent Application Publication
(10) Pub. No.: US 2008/0053746 A1
(43) Pub. Date: Mar. 6, 2008

(54) NOISE REDUCTION SHROUD

(76) Inventors: Roger W. Albert, Plymouth, WI (US); Charles M. Imig, Appleton, WI (US); Daniel J. Luhman, Kohler, WI (US); Edward A. Uebelher, Fond du Lac, WI (US); Steve P. Lewis, Howards Grove, WI (US)

Correspondence Address: WHYTE HIRSCHBOECK DUDEK S C, 555 EAST WELLS STREET, SUITE 1900, MILWAUKEE, WI, 53202, US

(21) Appl. No.: 11/468,625

(22) Filed: Aug. 30, 2006

(51) Int. Cl. H02K 5/24; G10K 11/00

(52) U.S. Cl. 181/202; 181/205

(57) ABSTRACT

A noise reduction shroud is provided for use with utility engines that have attached blower housings. The shroud comprises a one-piece shell positioned above and around the blower housing located on the engine to define a space between the shroud and the engine, wherein the shell is adapted such that air entering the blower housing must first flow from a bottom side of the engine up through the space between the shroud and the engine. In another embodiment, the invention is a lawnmower or other lawn and garden equipment, comprising such a noise reduction shroud.

### FIELD OF THE INVENTION

The present invention relates to utility engines, particularly noise reduction shrouds for small engines.

### BACKGROUND OF THE INVENTION

The maximum permissible sound power level of lawnmowers has been regulated in Europe since the mid-1980's. Historically, the cutting deck noise has been the dominant noise source of lawnmowers, Engine noise has not been a significant noise source. On Jan. 3, 2002, the European Noise Directive for Outdoor Power Equipment (2000/14/EC) came into force within the European Union. Lawnmower manufacturers have reduced the designed operating speed of lawnmowers to comply with the requirements of this directive. Engine speeds as low as 2500 RPM with an engine load of approximately 20% rated load are typical. This directive proposes a further reduction in the maximum permissible sound power level of approximately 2.0 dBA on Jan. 3, 2006.

In the outdoor power equipment industry, the reduction of lawnmower noise is usually accomplished by reducing cutting deck speed. Reductions in lawnmower cutting deck noise have also been achieved by modifications to the cutting blades—specifically, the elimination of features of the cutting blade that creates lift of grass prior to cutting. Reductions in lawnmower noise have also been achieved by placing a seal around the perimeter of the cutting deck. Each of these lawnmower design modifications degrades the grass cutting performance of the cutting deck. The seal around the perimeter of the cutting deck adds cost to the lawnmower and presents a safety problem related to the ingestion and shredding of the seal beneath the cutting deck. The advantage of this invention is the reduction of lawnmower noise without loss of grass cutting performance or safety concerns related to ingestion by the cutting deck. This invention takes advantage of the acoustic environment specified for the European lawnmower noise test and actual use of a lawnmower-operation over turf or artificial flooring.

In the European lawnmower noise test (ISO 11094), a lawnmower is operated over natural turf or over artificial flooring. Artificial flooring is a sound absorbing platform. In either case, considerable acoustic energy is absorbed by the surface beneath the lawnmower. In this test, acoustic measurements are made using microphones placed above the lawnmower.

Over the past two years, lawnmower manufacturers have made significant progress reducing cutting deck noise. In some cases, cutting deck noise may have been reduced to near the level of the engine noise. In such cases, further reduction of the overall lawnmower noise level will require reducing the engine noise as well as the cutting deck noise.

### BRIEF SUMMARY OF THE INVENTION

The hallmark of this invention is providing an acoustic barrier between the noise sources of a utility engine and the receiver (i.e., the operator). It is also a hallmark of this invention to redirect the major noise sources of utility engine noise, at the operating conditions of the European Union lawnmower noise test, towards a sound absorbing surface.

In one embodiment, the invention is a noise reduction shroud for use with utility engines that have attached blower housings, the shroud comprising: a one-piece shell positioned above and around a blower housing located on an engine to define a space between the shroud and the engine, wherein the shell is adapted such that air entering the blower housing must first flow from a bottom side of the engine up through the space between the shroud and the engine. In another embodiment, the invention is a lawnmower or other lawn and garden equipment, comprising such a noise reduction shroud,

### BRIEF DESCRIPTION OF THE DRAWINGS

FIG. 1 shows a schematic side view of a prior art engine blower housing.

FIG. 2 shows the shroud redirecting the cooling system noise and the induction system noise of the engine to exit towards the bottom of the engine.

FIG. 3 shows the shroud redirecting the cooling system noise and the induction system noise of the engine to exit towards the bottom of a liquid cooled engine.

FIG. 4 shows the geometrical configuration for wave propagation over a layered boundary.

### DETAILED DESCRIPTION OF THE PREFERRED EMBODIMENT

Utility and lawn and garden equipment include lawnmowers, chainsaws, blowers, string trimmers, generator sets, pumps, and other equipment powered by small (<25 hp) gasoline and diesel engines. As used herein, the term “utility engine” means an engine typically rated under 50 horsepower and typically used to power outdoor power equipment and industrial applications.

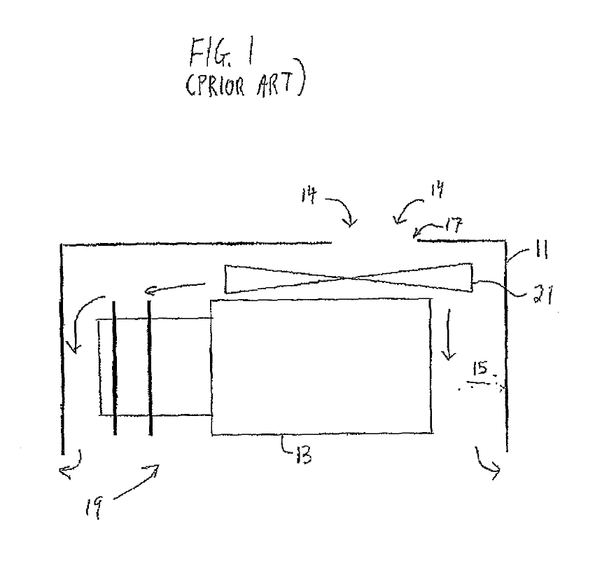

Utility engines are typically cooled by forced air. As shown in FIG. 1, a blower housing 11 is placed around an engine 13 such that a gap 15 exists between the blower housing 11 and the engine 13. Cooling air 14 flows through the gap 15 between the engine 13 and the blower housing 11 (shown by arrows). The cooling air 14 enters the gap 15 through an inlet 17 in the blower housing 11 and is subsequently discharged through an outlet 19 in the blower housing 11. Generally, for utility engines, the blower housing inlet 17 is located on the top of the blower housing 11 (as shown) but other orientations are possible. The cooling air 14 is typically forced through the gap 11 by means of a fan 21 or other similar means. The blower housing 11 is designed to direct the cooling air 14 against the engine 13 in order to provide the proper cooling.

On most types of outdoor power equipment and particularly zero-turn radius lawnmowers, the operator position is above the utility engine. Therefore, the operator ear position is above the engine. On zero-turn radius lawnmowers, the operator sits directly in front of the engine with a direct and short path to the operator's ears. When the utility engine has the blower housing inlet orientated to the top of the blower housing, engine noise can propagate relatively unimpeded through the blower housing inlet directly towards the operator. As such, the operator is exposed to a high noise-level environment. As explained more fully below, the invention serves to mitigate the noise exposure of the operator by imposing an acoustic barrier between the noise source and the operator.

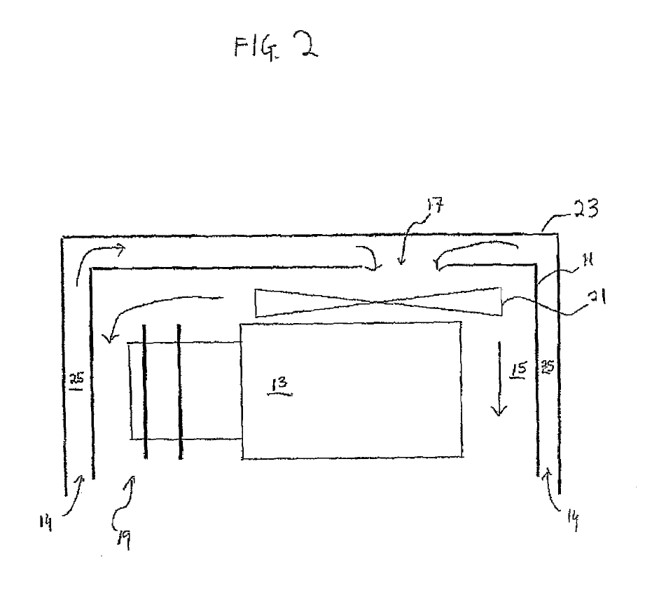

Referring to FIG. 2, a noise reduction shroud 23 is attached over the engine crankcase and/or the engine blower housing 11. Preferably, the shroud 23 is attached so as to be readily removable to allow for maintenance and repair of the underlying engine or blower housing 11. The shroud 23 is generally made as a single piece. The shroud 23 is constructed out of any of the well-known suitable materials, such as steel, aluminum, or polymeric resins. The choice of the shroud construction material is guided by usual design considerations such as strength, impact resistance, weight, operating temperature, weather resistance, and the like.

The shroud 23 covers the cooling air inlet 17 of the engine blower housing 11. The height of shroud 23 is taller than the engine blower housing 11. Shroud 23 is also wider than the engine blower housing 11 creating a second gap 25. Therefore, shroud 23 does not block the flow of engine cooling air to the blower housing inlet 17. Shroud 23 redirects the cooling air to the engine. Cooling air 14 flows through gap 25 to reach inlet 17 of blower housing 11. The cooling air 14 enters the blower housing 11 through inlet 17, is distributed by blower 21 and exits housing 11 through outlet 19. The height and width of shroud 23 are determined by the cooling and airflow requirements of the engine.

While allowing cooling air 14 to flow, shroud 23 operates as an acoustic barrier. Shroud 23 redirects the cooling system noise and the induction system noise of the engine to exit towards the bottom of the engine. This noise would normally exit towards the top of the engine out of the opening in the blower housing.

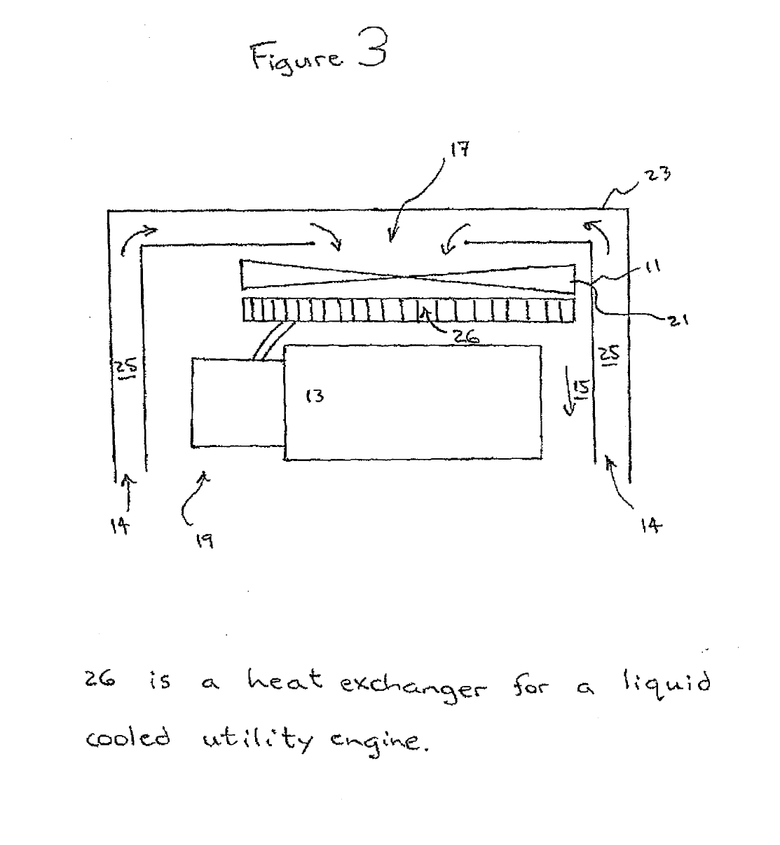

In a further embodiment, this invention can be used with a liquid cooled engine as shown in FIG. 3. As shown in FIG. 3, the air flow path is the same as from air cooled engine shown in FIG. 2. However, heat exchanger 26 is provided to cool liquid used to cool the utility engine. Cooling air 14 enters the blower housing 11 through inlet 17 and is forced by blower 21 through heat exchanger 26. The contact of cooling air 14 with heat exchanger 26 allows the transfer of heat energy through the cooling liquid to the cooling air 14.

By forcing the cooling system noise and induction system noise to exit from the bottom of the engine rather than the top of the engine, two acoustic benefits are realized. First the direct radiation of these noise sources to the operator ear position is avoided. Typically, the operator of a piece of outdoor power equipment is located above the engine. Therefore, there is typically a direct path for these noise sources to the operator's ears. Second, a significantly greater percentage of acoustic energy from these noise sources will be absorbed by the turf or artificial flooring.

As mentioned in the previous section, the application of sound absorption to reduce noise is well known. Materials which absorb sound change the energy of motion of molecules into heat by exciting other motion, Manufacturers of outdoor power equipment have recognized the acoustic benefit of sound absorption for several decades. Manufacturers of such equipment choose the type of turf to use for acoustic testing based on the desire to have a high sound absorption coefficient. The sound absorption coefficient is defined as follows:

$$∝ ( f ) = \frac{Ia}{Ii}$$

### Where:

∝(f)=absorption coefficient

### Ia=acoustic energy absorbed by the material

### Ii=acoustic energy incident on the material

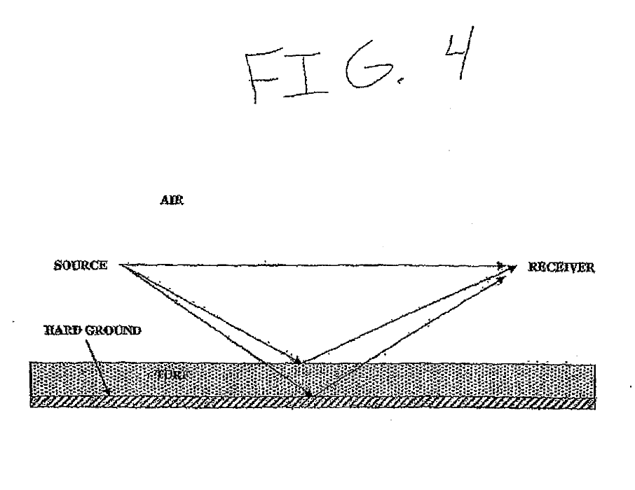

FIG. 4 shows the geometrical configuration for wave propagation over a layered boundary. The top layer is assumed to be air, which has a density ρ₀ speed of sound c₀, and acoustic impedance ρ₀c₀. The middle layer is assumed to be either turf or artificial flooring, which is a porous material with its density and speed of sound being a complex quantity. In other words, the turf/artificial flooring layer has a complex acoustic impedance such that a plane wave transmitted from the air into this layer will be refracted into the layer with a phase shift, and will be attenuated as it propagates through this material. The sound absorption coefficient varies significantly with the type of turf. The sound absorption coefficient is related in part to the void-to-volume ratio. Sound absorption coefficients for turf vary from 0.5 to 0.7. Artificial flooring is required to be constructed of mineral fiber, 20 mm thick, having an airflow resistance of 11 kNs/m⁴ and a density of 25 kg/m³. These features of artificial flooring provide a sound absorption coefficient approximately equal to natural turf. Therefore, there is significant acoustic advantage to be gained in the test setup for a European lawnmower noise test for redirecting unwanted sound waves (i.e., noise) towards the turf/artificial flooring beneath the lawnmower.

As mentioned in the previous section, the application of a barrier to reduce transmitted sound is well known. Nonporous walls of mass density greater than approximately 20 kg/m² may be used effectively as a noise barrier. The sound reaching the receiver must diffract around the barrier. Since a majority of the sound does not diffract, the noise reaching the receiver is significantly reduced. Acoustic barriers are effective at reducing noise at the receiver position if the barrier has sufficient mass density, the barrier obstructs the line of sight between the receiver and the noise source, and the barrier has no openings that reduce the transmission loss. The utility engine noise reduction shroud 23 will achieve all these aspects of acoustic barrier design. To economically achieve the density requirement for an acoustic barrier, it may be necessary to line the inside portion of shroud 23 with an acoustic barrier material.

Known acoustic barrier materials include noise-insulating panels made of self-supporting, thermoset materials such as reaction injection molded polyurethanes, and thermoplastic materials, such as highly filled ethylene vinyl acetate copolymer, polyvinyl chloride and polypropylene.

This invention will also provide an acoustic benefit for operators of outdoor power equipment, particularly operators of zero-turn radius lawnmowers.

What is claimed is:

1. A noise reduction shroud for use with utility engines that have attached blower housings, the shroud comprising: a one-piece shell positioned above and around a blower housing located on an engine to define a space between the shroud and the engine, wherein the shell is adapted such that air entering the blower housing must first flow from a bottom side of the engine up through the space between the shroud and the engine.

2. The shroud of claim 1, wherein the blower housing has an inlet for cooling air on side located above the engine and an outlet for the cooling air located below the engine.

3. The shroud of claim 1 further comprising a lining comprising at least one acoustic barrier material.

4. The shroud of claim 3, wherein the acoustic barrier material is a nonporous material having a density greater than about 20 kg/m².

5. The shroud of claim 1, wherein the engine is liquid-cooled and the cooling air is forced into contact with a heat exchanger.

6. A lawnmower having a utility engine with an attached blower housing, the lawnmower comprising a noise reduction shroud, the shroud comprising: a one-piece shell positioned above and around a blower housing located on an engine to define a space between the shroud and the engine, wherein the shell is adapted such that air entering the blower housing must first flow from a bottom side of the engine up through the space between the shroud and the engine.

7. The lawnmower of claim 6, wherein an operator of the lawnmower is positioned above the engine.

8. The lawnmower of claim 7, wherein the noise reduction shroud is located between the engine and the operator.

9. The lawnmower of claim 7, wherein the noise reduction shroud directs engine noise away from the operator.

10. The lawnmower of claim 6, wherein the lawnmower is a zero-turn radius lawnmower.

11. The lawnmower of claim 6 wherein the shroud further comprises an acoustic barrier material.

12. The lawnmower of claim 6, wherein the engine is liquid-cooled and further comprises a heat exchanger.

13. A method to reduce noise exposure to an operator of equipment comprising a utility engine that has an attached blower housing, the method comprising:
placing a noise reduction shroud over the utility engine such that the noise reduction shroud is located between the utility engine and the operator,
wherein the shroud comprises a one-piece shell that is positioned above and around the blower housing located on the engine to define a space between the shroud and the engine, wherein the shell is adapted such that air entering the blower housing must first flow from a bottom side of the engine up through the space between the shroud and the engine.

14. The method of claim 13, wherein the shroud is adapted to direct engine noise away from the operator.

15. The method of claim 13, wherein the shroud further comprises a lining of a acoustic barrier material.

16. The method of claim 13 wherein a heat exchanger is located within the blower housing.

17. The method of claim 13 wherein at least some of the air entering the blower housing is forced against the heat exchanger.
